(19) United States
(12) Patent Application Publication
(10) Pub. No.: US 2023/0117930 A1
(43) Pub. Date: Apr. 20, 2023

(54) Positive Pressure Respirator Assembly

(71) Applicant: Brandon King, Eagle Mountain, UT (US)

(72) Inventor: Brandon King, Eagle Mountain, UT (US)

(21) Appl. No.: 17/695,785

(22) Filed: Mar. 15, 2022

Related U.S. Application Data
(60) Provisional application No. 63/161,428, filed on Mar. 15, 2021.
(60) Provisional application No. 63/161,443, filed on Mar. 15, 2021.

(51) Int. Cl. A62B 18/04; A62B 7/12

(52) U.S. Cl. CPC A62B 18/04; A62B 7/12; A62B 18/006

(57) ABSTRACT

An embodiment of a positive pressure loose-fitting head device, such as a hood, helmet or headgear, with exhaustion conduit directing exhaust into user's PPE is shown; there may be an outflow/exhaust drain; there may be a outflow/exhaust tube/conduit under shroud into PPE; there may be connections for add-ons (controls, dampers, valves, diffusers, filters . . . ); there may be an outer shroud and an inner shroud; there may be purified air from power unit; there may be an inflow location.

### CROSS-REFERENCE TO RELATED APPLICATIONS

This present application claims the benefit, and incorporates by reference, the provisional patent application with a Ser. No. 63/161,428 and a filing date of Mar. 15, 2021; this present application also claims the benefit, and incorporates by reference, the provisional patent application with a Ser. No. 63/161,443 and a filing date of Mar. 15, 2021.

A positive pressure respirator may have a hood/helmet/headgear, with exhaust outlet and hose, directing exhaust into the user's torso PPE.

### BACKGROUND OF THE INVENTION

Powered Air Purifying Respirators (PAPRs) and Supplied Air Respirators (SARs) are types of respiratory Personal Protective Equipment (PPE) used by industrial and medical workers to protect themselves in environments where the air is contaminated, harmful or uncomfortable for breathing.

A typical PAPR consists of a hip-mounted power pack/blower/filtering unit, and an air hose and a typical SAR consists of either an air-cylinder or an air-line from a remote power supply compressor/filtering unit. Both PAPRs and SARs provide breathable air to a positive pressure, loose-fitting hood/helmet/headgear. These hoods, helmets and headgear have various levels/layers of physical PPE, ranging from an above the ear hood used in hospitals, to a welder's helmet with high temperature shroud. While the physical levels/layers of PPE vary with this type of hoods/helmets/headgear, they all share the same type of respiratory PPE with similar components and functionality. Hereinafter referred to as PAPR hoods.

PAPR hoods currently have an inflow for purified air that is continuously forced into the PAPR hood from the power unit creating a positive pressure within the PAPR hood. PAPR hoods do not have a specific outflow for exhaust, instead, they are designed to “overflow” exhaust around the lower edge of the PAPR hood along the loose-fitting elastic, drawstring or shroud, above or around the user's neck, effectively creating a continuous one-way exhaust seal. This PAPR hood exhaust contains excess purified air mixed with the user's respiratory droplets and aerosols that fall down the exterior of the user's torso PPE.

Some embodiments of a PAPR hood, include a drawstring for tightening the fit of the hood around a user's chin.

### BRIEF DESCRIPTION OF THE DRAWINGS

FIG. 1 depicts some embodiments of a positive pressure, loose-fitting hood, helmet, or headgear, as well as some embodiments of a diffuser and an exhaust reservoir;

FIG. 2. depicts some embodiments of a positive pressure, loose-fitting hood, helmet, or headgear, having an exhaust outlet and conduit

FIG. 3. depicts some embodiments of loose fitting, positive pressure PAPR or SAR hood, helmet or headgear

FIG. 4. depicts some embodiments of a positive pressure respirator loose-fitting device.

### SUMMARY OF THE INVENTION AND DETAILED DESCRIPTION

This invention is an improvement to existing PAPR hoods, by adding an exhaust outlet and tube to direct the PAPRs purified air exhaust and the user's unpurified respiratory exhaust into the user's torso PPE. This invention utilizes the users required torso PPE as a safe and effective way to isolate or contain the user's respiratory droplets and aerosols from the work area, operating table, or patient below. This invention may increase source control for PAPR hoods.

This invention may contribute to improving upon the traditional PAPR hood design in at least one of the following areas:
1. Worker fatigue: PAPR hoods are used in conjunction with other types of PPE to protect the user's body. This body PPE may be a sterile surgical gown, a disposable isolation gown, a welder/s leather jacket, or a HAZMAT jumpsuit. This body PPE restricts air circulation and inhibits the user's evaporative cooling physiology from working. Some embodiments of the invention may use the PAPR power supply and fan to direct the PAPR hoods outflow/exhaust toward the sternum and chest of the user. This may cool the user, decreases user fatigue, and decreases user dehydration.
2. Transmission of infectious respiratory disease: The user's respiratory exhaust contains respiratory droplets and aerosols and is exhausted from the PAPR hood above patients and work area. Some embodiments of this invention may direct respiratory exhaust into the torso PPE of the user, thereby filtering/isolating much of the user's respiratory exhaust from the work area or patient using the required torso PPE which may, thereby, increase the source control of PAPR hoods.
3. User's ability to hear: The temples of eyewear sit just above the user's ears, causing a larger gap between the user's face and the PAPR hood. The PAPR hood's positive pressure causes a constant exhaust flow across the user's ears, hindering communication. This invention may direct some of the air away from the ears and toward the chest of the user, which may facilitate communication between a user and someone else.

Some embodiments of a PAPR hood have an
inlet (which may be termed an inflow and may be configured to connect to another component);
a hood body (that may be non-permeable);
a face shield;
a restrictor (which may be a drawstring, clasp, closure, and may be elastic and may allow for a loose-fitting connection between the restrictor and the thing that is to be restricted, such as an opening of a tube that is to be restricted around a valve, outlet, or housing coupled to an outlet);
an outlet (that may allow for the passage of outflow, exhaust, or air) (the outlet may or may not a valve, but in the preferred embodiments the outlet is valveless); and,
an outflow/exhaust tube that may, in some embodiments, may be coupled or communicatively-coupled to the outlet.

Additional Descriptions:

The inlet may have an attachment/connection point, or a connection portion, that is couplable to a hose adapted for the transportation of air; in some embodiments the inlet has a valve; in some preferred embodiments the inlet does not have a valve, thereby allowing for valveless entry of breathable air into the hood body.

The hood body may be non-permeable; the hood body may serve as a contact barrier, may provide positive pressure entrapment, and may be an attachable base to which portions of the hood may be attached. The improved PAPR hood may have a face shield, which may be transparent and may provide a surface that protects a worker's vision; a tightener, which may be a clasp, a drawstring or an elastic device for tightening material by decreasing the distance between at least two edges of a material (the tightener may surround an outflow tube (which may also be termed an exhaust tube or an outflow/exhaust tube) and direct the direction of the outflowing exhaust to outflow from the PAPR hood. In the preferred embodiments, the outflow tube directs the outflow into torso PPE, such as into a user's garments, shirt, or gown such that the outflow is directed downwards substantially towards a user's shoes.

An air hose or power unit/blower/filter that may be coupled to the waist may be operably coupled to the PAPR hood; alternatively an air house or power unit/blower/filter may be located remotely.

Positive pressure, breathable air is forced to the PAPR hood through an air hose that interacts/attaches to the inlet, which may be located in the posterior of the PAPR hood.

The hood body is the foundation for all PAPR hood parts and may be made of non-permeable material that may protect the wearer from physical environmental hazards. The hood body may encapsulate or contain a respiratory zone, which is herein defined as an area of positive pressure, which includes breathable air located adjacent to the user's mouth and nose.

A transparent face shield may be disposed within the hood body to provide a view of the work area and workers face, while maintaining worker protection, and the respiratory zone.

The tightener, which may be a clasp, a drawstring or an elastic device for tightening material by decreasing the distance between at least two portions of an edge, may be attached to the rim, such as the inferior rim, of the PAPR hood's respiratory zone, which may allow for continuous or intermittent overflow of exhaust. A PAPR hood may create a positive pressure respiratory zone by intaking breathable air and reducing/restricting the outflowing exhaust at the tightener. An adjustable respiratory zone may be adjusted by increasing or decreasing intake and/or outflow/exhaust.

An improved PAPR hood may have a valveless outflow/exhaust port(s), which may allow for a portion of the respiratory zone exhaust to flow through the outflow/exhaust port(s), and may provide an attachment point to the disposable/reusable outflow/exhaust tube.

The improved PAPR hood may include at least one outflow/exhaust tube(s), which may allow the user to direct outflow/exhaust into the torso PPE. In the preferred methods of use, respiratory exhaust is directed into a user's torso PPE.

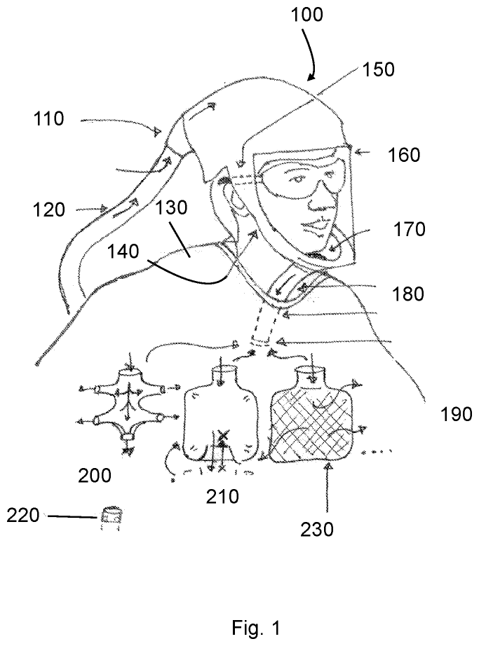

Referring to FIG. 1, a diffuser may vent outflow into at least one direction, such as towards a first arm pit and second arm pit.

Although the preferred embodiments use a loose-fitting, hoods, helmets or headgears, embodiments of the invention may also be used with tight-fitting hoods, helmets or headgears. Quick connect connectors may be used. Tube holders or adjustable tube holders may be used; some embodiments may be spring-loaded and may have a tube and may have a clip that may be clippable to a gown, shirt, or piece of clothing; embodiments of the invention may include at least one exhaust outlet.

Referring to a drawstring rim, an adjustable rim, which may be a drawstring rim, may be an edge through which things flow out of.

In some embodiments, it is possible to add a flow sensor or an end-tidal CO2 monitor in or on the outflow/exhaust tube that can be communicated to the power unit. This could direct the power unit to increase flow into the PAPR hood.

Referring to FIG. 1, a positive pressure loose-fitting head device (100), such as a hood, helmet or headgear, with exhaustion conduit directing exhaust into user's PPE; an inlet (110) is shown at the upper left corner; purified air from a power unit may travel towards the inlet and through an air hose 120; the user may be wearing PPE (130) on the user's torso and body; at the upper portion of the PPE may be a loose-fitting elastic/drawstring rim (140); there may be safety googles/prescription eyewear (150) in which temples run beneath the loose-fitting rim of the hood; a face mask (160) may be included; an outflow outlet (drain) (new) (170) may be included; an outflow/exhaust tube/conduit (180) may be directed into body PPE; there may be an attachment (190) for possible valves, filters, diffusers, venturi (such as a system for speeding the flow of fluid, by constricting it in a cone shape tube); there may be a diffuser (200); there may be an exhaust reservoir with at least one valve (210); an in line flow restrictor or other type of controller, dampers, or valve (220); there may be a respiratory exhaust filter (230);

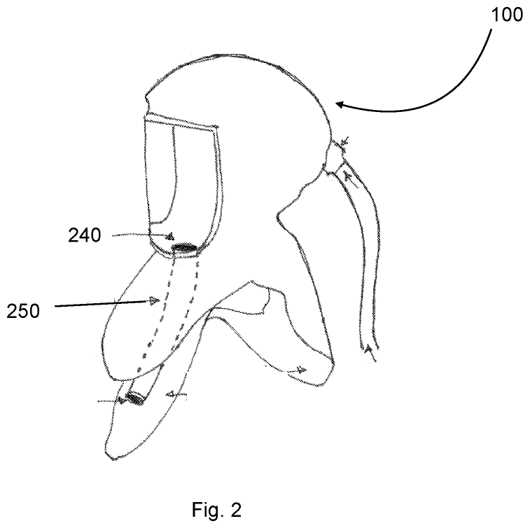

Referring to FIG. 2, an embodiment of a positive pressure loose-fitting head device (100), such as a hood, helmet or headgear, with exhaustion conduit directing exhaust into user's PPE is shown; there may be an outflow/exhaust drain (240); there may be a outflow/exhaust tube/conduit (250) under shroud into PPE; there may be connections for add-ons (controls, dampers, valves, diffusers, filters . . . ); there may be an outer shroud and an inner shroud; there may be purified air from power unit; there may be an inflow location;

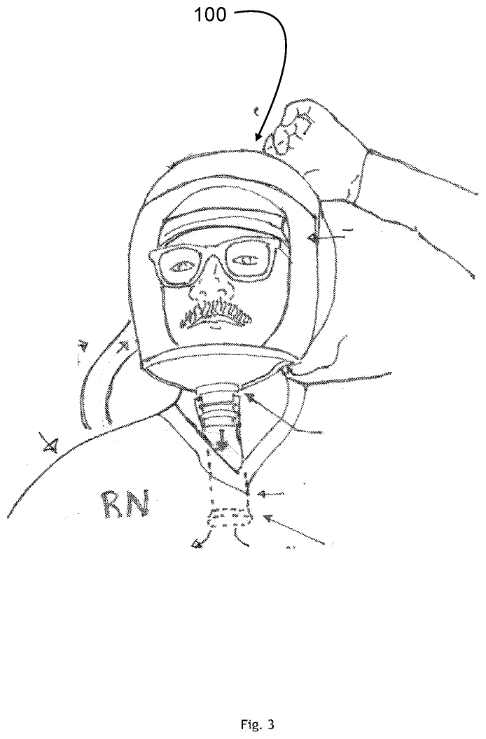

Referring to FIG. 3; there may be inflow from a power unit; there may be torso/body PPE; there may be a position for PAPR overflow and user's respiratory exhaust that may travel into a user's PPE; there may be a portion of an outflow tube/conduit for connecting to add-ons; there may be an outflow tube/conduit; there may be a loose-fitting elastic or drawstring; there may be a transparent face shield;

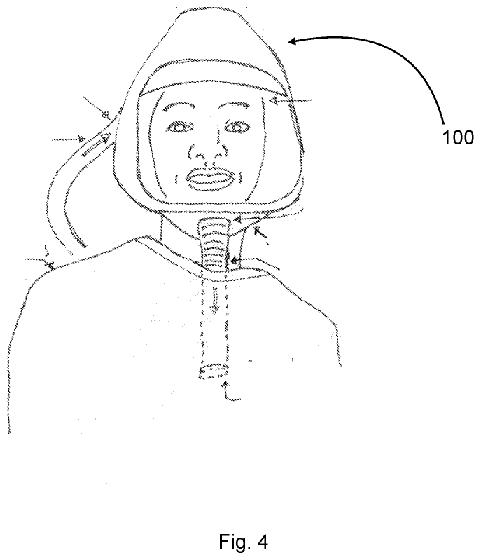

Referring to FIG. 4; there may be inflow from a power unit; there may be a air hose; there may be torso/body PPE; there may be a face shield; there may be an exhaust outlet (drain); there may be a loose-fitting drawstring or elastic; there may be an outflow/exhaust tube/conduit; there may be a connection for add-ons, controls, dampers, valves, diffusers, etc.

1. A positive pressure respiratory assembly comprising at least one selected from a group consisting of a hood, helmet, and headgear; the positive pressure respiratory assembly further comprising an exhaust outlet and a hose directing exhaust into a user's torso personal protection equipment.
